(19) United States
(12) Patent Application Publication
(10) Pub. No.: US 2026/0338422 A1
(43) Pub. Date: Oct. 29, 2026

(54) SPRAY BAR APPARATUS FOR TUMBLER CHILLING

(71) Applicant: Messer Industries USA, Inc., Bridgewater, NJ (US)

(72) Inventor: Todd Fath, Forest, VA (US)

(73) Assignee: Messer Industries USA, Inc., Bridgewater, NJ (US)

(21) Appl. No.: 19/637,047

(22) Filed: Apr. 2, 2026

Related U.S. Application Data
(60) Provisional application No. 63/796,516, filed on Apr. 29, 2025.

(51) Int. Cl. F25B 19/00

(52) U.S. Cl. CPC F25B 19/005

(57) ABSTRACT

There is provided and apparatus for dispensing a chilling medium into an interior of a tumbler for a product, which includes a support frame constructed and arranged to be mounted to a sidewall of the tumbler; an exhaust supported by the support frame; an actuator mounted to the support frame and constructed for reciprocal movement at the support frame; and a spray bar connected to the actuator for movement with the actuator, the spray bar constructed and arranged to be movable through the exhaust and the sidewall for being selectively positioned at the interior of the tumbler, and having a passageway therethrough for the chilling medium to be provided through the passageway of the spray bar to the interior chamber.

### BACKGROUND OF THE INVENTION

The present embodiments relate to apparatus used to chill for example food products and pharmaceutical products in tumblers or related devices for chilling.

The use of tumblers and other similar devices are known for chilling products such as food or pharmaceuticals with carbon dioxide (CO₂). However, the use of CO₂ for the known chilling of these types of products and the equipment to do so have at least two disadvantages. First, CO₂ as a supplied commodity is subject to supply disruptions and does not chill or freeze as efficiently as do other gas or liquid products. Second, known apparatus provide or deploy the CO₂ into a tumbler at a fixed position that is too remote from the product being chilled and processed.

### SUMMARY OF THE INVENTION

The present embodiments enable processers to use liquid nitrogen N₂ (LIN) instead of CO₂ for chilling of products in tumblers and like devices. The products may be food products or pharmaceutical products, liquid or otherwise, or other substances and compositions that can be chilled with cryogen to facilitate further processing, storage and/or distribution.

The present embodiments provide for the delivery of the LIN proximate to the products being chilled and are directed to an apparatus that is movably mounted for actuation at an interior of the tumbler.

In that regard, there is provided herein an apparatus embodiment for dispensing a chilling medium into an interior of a tumbler for a product, that includes a support frame constructed and arranged to be mounted to a sidewall of the tumbler; an exhaust supported by the support frame; an actuator mounted to the support frame and constructed for reciprocal movement at the support frame; and a spray bar connected to the actuator for movement with the actuator, the spray bar constructed and arranged to be movable through the exhaust and the sidewall for being selectively positioned at the interior of the tumbler, and having a passageway therethrough for the chilling medium to be provided through the passageway of the spray bar to the interior chamber.

The present embodiments are constructed and arranged to selectively position the LIN injection region further into the tumbler in close proximity to the product being chilled, as compared to the limitation of known CO₂ tumbler injection systems. An actuatable spray bar of the present embodiments is moveable from inside an exhaust duct elbow to and from an interior chamber of the tumbler. The injection of the LIN can therefore be moved closer to an interior of the tumbler to provide increased efficient use of the LIN with the product being processed, since the LIN spray is not exhausted before its use in the tumbler.

The present embodiments include an automated actuator which improves safety operations and reduces if not eliminates operator error and injury potential during movement of the spray bar apparatus.

### BRIEF DESCRIPTION OF THE DRAWINGS

For a more complete understanding of the present invention, reference may be had to the following description of exemplary embodiments considered in connection with the accompanying drawing Figures, of which:

FIG. 1 is a schematic showing a front perspective view of an embodiment of a spray bar apparatus according to the present invention.

FIG. 2 is a schematic showing a side plan view of the embodiment in FIG. 1 in the retracted position according to the present invention.

FIG. 3 is a schematic showing a bottom plan view taken along arrows 3-3 in FIG. 2.

FIG. 4 is a schematic showing a side plan view of the embodiment in FIG. 2 in the deployed position according to the present invention.

FIG. 5 is a schematic showing a bottom plan view taken along arrows 5-5 in FIG. 4.

FIG. 6 is a schematic showing a top plan view taken along arrows 6-6 in FIG. 4.

### DETAILED DESCRIPTION OF THE INVENTION

Before explaining the inventive embodiments in detail, it is to be understood that the invention is not limited in its application to the details of construction and arrangement of parts illustrated in the accompanying drawings, if any, since the invention is capable of other embodiments and being practiced or carried out in various ways. Also, it is to be understood that the phraseology or terminology employed herein is for the purpose of description and not of limitation.

In the following description, terms such as a horizontal, upright, vertical, above, below, beneath and the like, are to be used solely for the purpose of clarity illustrating the invention and should not be taken as words of limitation. The drawings are for the purpose of illustrating the invention and are not intended to be to scale.

As used in this specification, the terms “comprises”, “contains”, “containing”, “comprising”, “includes”, “including”, “has”, or “having”, are open-ended expressions and are intended to cover methods, processes, products, apparatus, or systems that comprise a recited list of components, elements, and features, and any and all additional components, elements and features that are not expressly recited.

In general, the present apparatus embodiments include a movable spray-bar with at least one or a plurality of nozzles, and an actuator (electric or hydraulic) for the spray bar to be operable with a tumbler for chilling products therein, such as food products and pharmaceutical products. The present embodiments may also include a cleaning or scraping member to remove frozen condensate or ice from the spray bar which increases operational efficiency, reduces operator error and improves safety and efficiency for product chilling applications. Efficiency of the chilling operation in the tumbler by the present embodiments can be improved to as much as 11% to 28%, as compared to known fixed-position or static (stationary) CO₂ spray horn configurations.

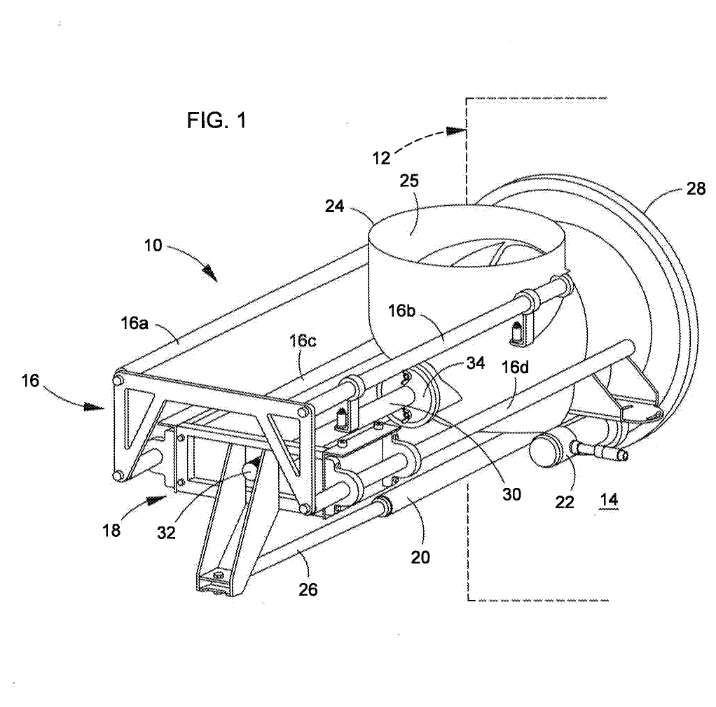

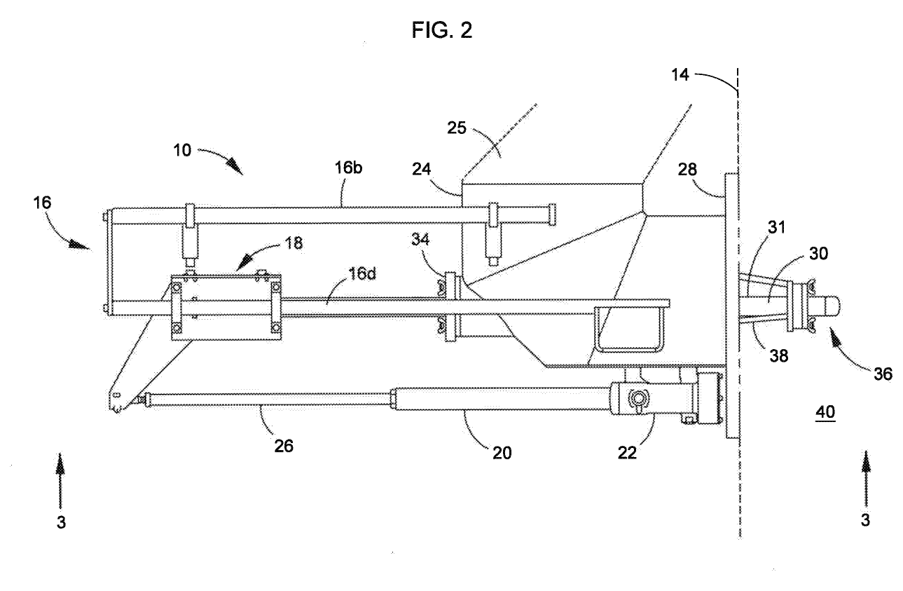

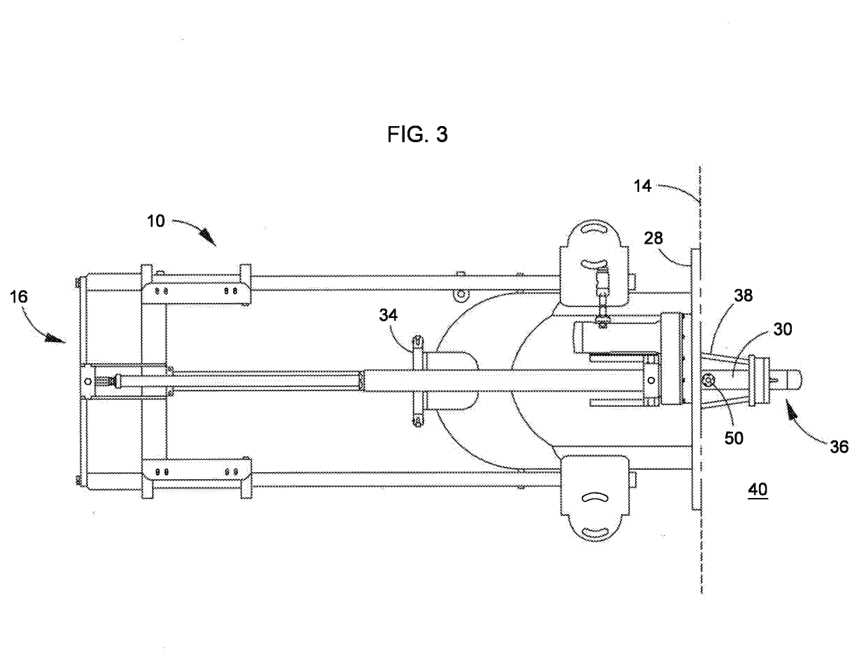

Referring now to FIGS. 1-3, a spray bar apparatus embodiment of the present invention is shown generally at 10 for use with a tumbler 12 or other similar device in which a product (not shown) such as a food product or pharmaceutical product is being processed or treated with a chilling substance or medium. The apparatus 10 is mounted to a sidewall 14 at a side of the tumbler 12 for introducing a cryogen such as nitrogen (N₂) into the tumbler. The N₂ will be introduced as liquid nitrogen (LIN) by the apparatus 10 into the tumbler 12 where it may phase change to an atomized N₂ spray in the tumbler as further described below. The introduction of the product into the tumbler 12 and the removal of the product from the tumbler upon completion of processing can be accomplished by known apparatus and methods.

The apparatus 10 includes a frame shown generally at 16 for supporting: a carriage or carrier assembly shown generally at 18; an actuator 20; a motor 22 for the actuator; and an exhaust 24. The apparatus 10 is movably positionable with respect to the sidewall 14 of the tumbler 12 with hinges or other mounting devices (not shown). A gasket 28 of the apparatus 10 removably engages or contacts the sidewall 14 when the apparatus is positioned for operations with the tumbler 12. The carrier assembly 18 is movable by the actuator 20. In effect, the frame 16 is removably mountable to the sidewall 14.

The frame 16 includes guide bars 16a,16b,16c,16d (16a-16d). More specifically, the motor 22 moves a piston 26 of the actuator 20, and an end of the piston is connected to the carrier assembly 18 for movably positioning the carrier assembly along the guide bars 16a-16d in relation to the tumbler 12.

The carrier assembly 18 includes and supports a spray bar 30 which is movable with the carrier assembly. The spray bar 30 is an elongated, hollow member (such as a tube or a pipe) through which the LIN is delivered to the tumbler 12, as will be described below. The spray bar 30 extends through the exhaust 24, wherein an external surface 31 of the spray bar is exposed to an atmosphere 25 in the exhaust. As shown in FIGS. 1-3, the carrier assembly 18 and the spray bar 30 are in the retracted position which can occur before or after the LIN has been introduced into the tumbler 12. A flexible hose or conduit (not shown) for the LIN is attached or connected to an end 32 of the spray-bar 30. The end 32 may be a threaded surface as shown or a bayonet mount (not shown), wherein either type of the end provides for a releasable engagement with the flexible hose or conduit. The LIN is delivered from a source (not shown) through the flexible hose or conduit to the spray bar 30. The exhaust 24 is in operation when the LIN is being provided to the spray bar 30.

A sanitary flange 34 or clamp is provided where the spray bar 30 extends through the exhaust 24 for a purpose to be described below.

A support assembly is shown generally at 38 for supporting the spray bar 30 where it extends from the sidewall 14 of the tumbler 12 into an interior 40 of the tumbler.

Still referring to FIGS. 1-3, the spray bar 30 is in a retracted position, wherein a distal end 36 of the spray bar is also in a retracted position with respect to the interior 40 of the tumbler 12. In the retracted position, the spray bar 30 is not delivering the LIN to the interior 40. The retracted position is used for when the product is being newly introduced to the interior 40 of the tumbler 12 or when chilled or processed product is to be removed from the tumbler for subsequent processing.

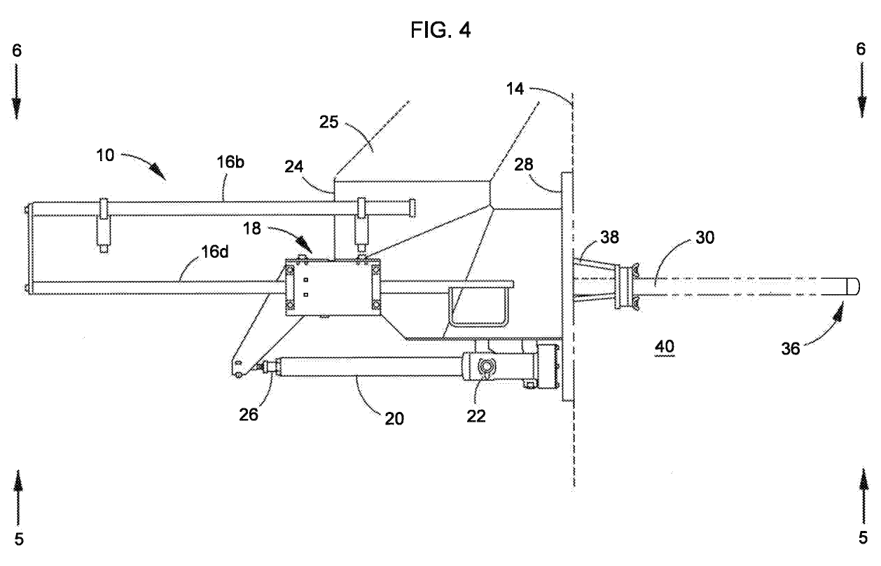

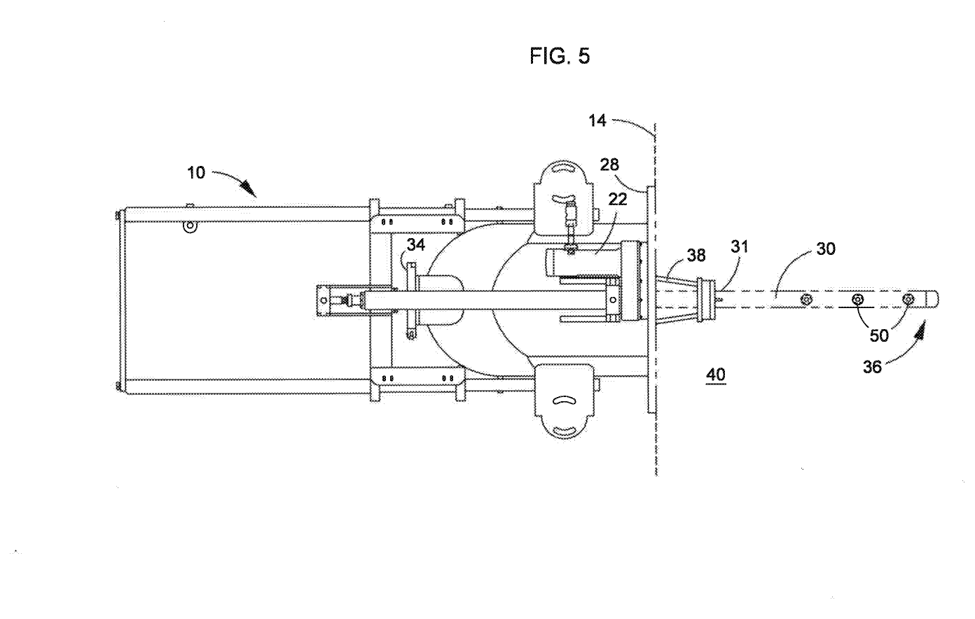

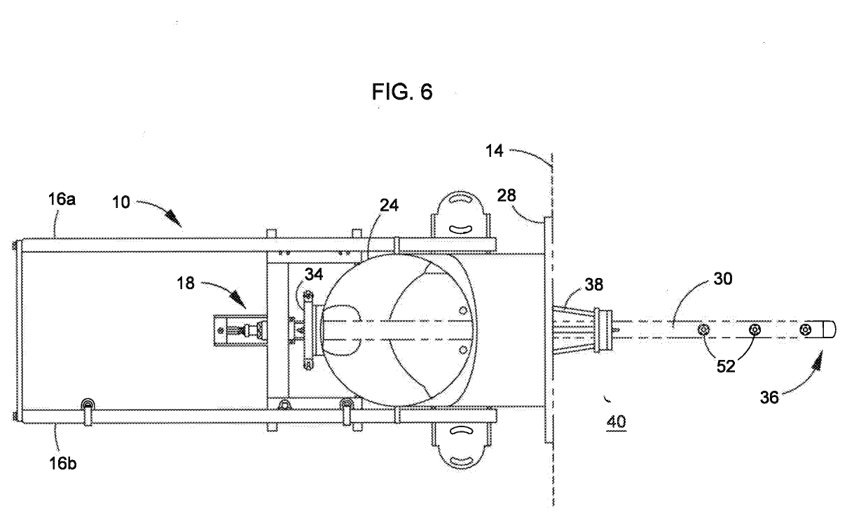

Referring now to FIGS. 4-5, the spray bar 30 can be and is extended for the distal end 36 to be moved further into the interior 40 of the tumbler 12 by movement of the carrier assembly 18 in order to deliver the LIN proximate to the product at the interior of the tumbler. The spray bar 30 includes at least one nozzle 50 (FIG. 5),52 (FIG. 6) or a plurality of the nozzles for spraying the LIN that is delivered from the flexible hose or conduit through the spray bar into the interior 40 of the tumbler 12, and for also spraying the LIN onto the product at the interior. The nozzles 50,52 are positioned as further described below. A spray pattern emitted from the at least one nozzle 50,52 will be that which best facilitates a uniform distribution of the LIN into the interior 40 and in certain applications onto the products for a thorough and uniform chilling of the mass of product at the interior.

As shown in FIG. 4, the carrier assembly 18 has been moved closer to the tumbler 12 by the motor 22 due to retracting the piston 26 into the actuator 20. Because the spray bar 30 is connected to the carrier assembly 18 which is operationally connected to the piston 26, the carrier assembly 18 is pulled toward the sidewall 14 and therefore, the spray bar is deployed or pushed to extend into the interior 40 of the tumbler 12 so that the LIN can be delivered to the product at the interior. During the deployment or extension of the spray bar 30 into the interior 40, there is usually no operation of the tumbler, although the deployment or extension of the spray bar can be accomplished during operation of the tumbler.

Referring to FIG. 5, the nozzle 50 or nozzles are mounted to the spray bar 30 to face downward from the spray bar toward the product, although it is understood that different configurations or arrangements of the nozzles can be used along the spray bar. The positioning of the nozzle(s) 50 in FIG. 5 for delivering the LIN is based upon a type or consistency of the product at the interior 40. That is, if the product at the interior 40 to be chilled is heavy or robust, such as whole chicken breasts or beef cutlets, the nozzle(s) 50 can be positioned to face downward into the interior toward the product because the delivery of the LIN from the nozzles will not destroy, disrupt or scatter the product throughout the interior as the tumbler 12 rotates. The product will remain substantially if not entirely at the bottom of the tumbler 12 below the spray bar 30 when the tumbler is rotating.

Referring to FIG. 6, the nozzle 52 or nozzles are mounted to the spray bar 30 to face upward from the spray bar away from the product, although it is understood that different configurations or arrangements of the nozzles can be used along the spray bar. The positioning of the nozzle(s) 52 in FIG. 6 for delivering the LIN is based upon a type or consistency of the product at the interior 40. That is, if the product at the interior 40 to be chilled is small and/or delicate, such as shrimp pieces, chicken fingers or a chicken nugget base, the nozzle(s) 52 can be positioned to face upward at the interior away from the product so the delivery of the LIN from the nozzles will not destroy, disrupt or scatter the product throughout the interior as the tumbler 12 rotates. In effect, when the LIN is delivered from the nozzle(s) 52 upward, the LIN will more readily phase change to a combination of smaller liquid nitrogen droplets and a gaseous chilling substance to rain down upon the product residing at the bottom of the tumbler below the spray bar 30. The product will remain substantially if not entirely at the bottom of the tumbler 12 below the spray bar 30 when the tumbler is rotating.

The sanitary flange 34, scrapper or clamp is provided to remove frozen concentrate which may have adhered to a surface of the spray bar 30 when same is retracted by the carrier assembly 18 from the tumbler 12 as shown in FIGS. 1-3.

The extension of the spray bar 30 from the position in FIGS. 1-3 to the extended or deployed position shown in FIGS. 4-6, and the delivery of the LIN to the spray bar 30 will inevitably lead to gaseous N₂ being produced and therefore emitted. Such phase change will, for safety and operational purposes, thereby require the gaseous cryogen to be exhausted from the apparatus 10 through the exhaust 24. This phase change to gaseous N₂ begins to occur as soon as the LIN is delivered to the spray bar 30 and throughout the continued delivery of the LIN until such time as the delivery ceases and the chilled product is removed from the tumbler 12.

The present embodiments of FIGS. 1-6 move or relocate the injection of the LIN cryogen deeper into the tumbler interior 40, i.e., the processing space for chilling, and further away from the exhaust 24 or the exhaust space, resulting in an increase of the chilling potential of the gaseous and liquid phases of the LIN utilized on the products, and a safer use of the LIN.

Illustrative embodiments of the apparatus for dispensing a chilling medium into an interior of a tumbler for a product of the present disclosure include:

In a first illustrative embodiment, provided is an apparatus for dispensing a chilling medium into an interior of a tumbler for a product, including a support frame constructed and arranged to be mounted to a sidewall of the tumbler; an exhaust supported by the support frame; an actuator mounted to the support frame and constructed for reciprocal movement at the support frame; and a spray bar connected to the actuator for movement with the actuator, the spray bar constructed and arranged to be movable through the exhaust and the sidewall for being selectively positioned at the interior of the tumbler, and having a passageway therethrough for the chilling medium to be provided through the passageway of the spray bar to the interior chamber.

According to a second illustrative embodiment there is provided the apparatus of the first illustrative embodiment, wherein the chilling medium includes a cryogenic substance.

According to a third illustrative embodiment there is provided the apparatus of the second illustrative embodiment, wherein the cryogenic substance includes liquid nitrogen (LIN).

According to a fourth illustrative embodiment there is provided the apparatus of the first illustrative embodiment, wherein the support frame is releasably mounted to the sidewall.

According to a fifth illustrative embodiment there is provided the apparatus of the first illustrative embodiment, further including a seal disposed to contact the sidewall where the support frame is mounted to the sidewall.

According to a sixth illustrative embodiment there is provided the apparatus of the first illustrative embodiment, wherein the spray bar includes at least one nozzle for dispensing the chilling medium from the passageway in the spray bar to the interior chamber of the tumbler.

According to a seventh illustrative embodiment there is provided the apparatus of the sixth illustrative embodiment, wherein the at least one nozzle is positionable to direct the chilling medium toward the product.

According to an eighth illustrative embodiment there is provided the apparatus of the sixth illustrative embodiment, wherein the at least one nozzle is positionable to direct the chilling medium away from the product.

According to a ninth illustrative embodiment there is provided the apparatus of the first illustrative embodiment, further including a cleaning member mounted to the support frame and disposed to contact the spray bar for removal of frozen material at an exterior surface of the spray bar.

According to a tenth illustrative embodiment there is provided the apparatus of the first illustrative embodiment, wherein the exhaust is constructed and arranged to capture and remove vapor from the chilling medium released from the spray bar.

According to an eleventh illustrative embodiment there is provided the apparatus of the first illustrative embodiment, further including a source of the chilling medium connected to the passageway of the spray bar.

According to a twelfth illustrative embodiment there is provided the apparatus of the first illustrative embodiment, wherein the spray bar is retractable away from the interior by the actuator.

It will be understood that the embodiments described herein are merely exemplary, and that a person skilled in the art may make variations and modifications without departing from the spirit and scope of the invention. All such variations and modifications are intended to be included within the scope of the invention as provided for in the appended claims. It should be understood that the embodiments described above are not only in the alternative but can be combined.

What is claimed is:

1. An apparatus for dispensing a chilling medium into an interior of a tumbler for a product, comprising:
a support frame constructed and arranged to be mounted to a sidewall of the tumbler;
an exhaust supported by the support frame;
an actuator mounted to the support frame and constructed for reciprocal movement at the support frame; and
a spray bar connected to the actuator for movement with the actuator, the spray bar constructed and arranged to be movable through the exhaust and the sidewall for being selectively positioned at the interior of the tumbler, and having a passageway therethrough for the chilling medium to be provided through the passageway of the spray bar to the interior chamber.

2. The apparatus of claim 1, wherein the chilling medium comprises a cryogenic substance.

3. The apparatus of claim 2, wherein the cryogenic substance comprises liquid nitrogen (LIN).

4. The apparatus of claim 1, wherein the support frame is releasably mounted to the sidewall.

5. The apparatus of claim 1, further comprising a seal disposed to contact the sidewall where the support frame is mounted to the sidewall.

6. The apparatus of claim 1, wherein the spray bar comprises at least one nozzle for dispensing the chilling medium from the passageway in the spray bar to the interior chamber of the tumbler.

7. The apparatus of claim 6, wherein the at least one nozzle is positionable to direct the chilling medium toward the product.

8. The apparatus of claim 6, wherein the at least one nozzle is positionable to direct the chilling medium away from the product.

9. The apparatus of claim 1, further comprising a cleaning member mounted to the support frame and disposed to contact the spray bar for removal of frozen material at an exterior surface of the spray bar.

10. The apparatus of claim 1, wherein the exhaust is constructed and arranged to capture and remove vapor from the chilling medium released from the spray bar.

11. The apparatus of claim 1, further comprising a source of the chilling medium connected to the passageway of the spray bar.

12. The apparatus of claim 1, wherein the spray bar is retractable away from the interior by the actuator.
